(19) United States
(12) Patent Application Publication
(10) Pub. No.: US 2024/0044178 A1
(43) Pub. Date: Feb. 8, 2024

(54) PADLOCK WITH REPLACEABLE LOCK HOOP

(71) Applicant: ABUS August Bremicker Sõhne KG, Wetter-Volmarstein (DE)

(72) Inventor: Wai Kuen FAN, Kowloon (HK)

(21) Appl. No.: 18/332,787

(22) Filed: Jun. 12, 2023

(30) Foreign Application Priority Data
Aug. 4, 2022 (DE) 102022119572.4

(51) Int. Cl. E05B 67/06; E05B 67/22

(52) U.S. Cl. CPC E05B 67/063; E05B 67/22

(57) ABSTRACT

A padlock comprising a lock body; a U-shaped lock hoop that has a circular cross-section, that is displaceably held at the lock body between a closed position and an open position, and that has a first hoop limb and a second hoop limb that is longer than the first hoop limb; and a locking device in the lock body for locking the lock hoop to the lock body in the closed position of the lock hoop. The locking device comprises at least one latch element and can be adjusted between a locked position, in which the latch element engages into an engagement recess in the closed position of the lock hoop, said engagement recess being formed in a flank of the second hoop limb facing the first hoop limb, and an unlocked position in which the latch element is located outside the engagement recess. In the second hoop limb, a peripheral groove is formed which is located closer to the free end of the second hoop limb than the engagement recess and into which the latch element engages in the open position of the lock hoop. The second hoop limb has a passage that extends between the free end of the second hoop limb and the peripheral groove and that has a surface that is recessed with respect to the circular cross-section of the lock hoop. The second hoop limb receives a blocking element between its free end and the peripheral groove, said blocking element projecting over the recessed surface of the passage in order to prevent, in the open position of the lock hoop, a passing of the latch element through the passage, starting from the peripheral groove.

### CROSS-REFERENCE TO RELATED APPLICATION

This application claims the benefit and priority of German Patent Application No. 102022119572.4 filed on Aug. 4, 2022. The entire disclosure of the above application is incorporated herein by reference.

### FIELD

The present invention relates to a padlock whose lock hoop may, if necessary, be replaced with another lock hoop, for example, with a shorter lock hoop or a longer lock hoop or with a lock hoop composed of a different material.

### BACKGROUND OF THE INVENTION

In conventional padlocks, the replacement of the lock hoop is comparatively difficult since, among other things, the lock cylinder has to be removed for this purpose. A padlock may comprise a lock body and a U-shaped lock hoop displaceably held thereat between a closed position and an open position. Apart from recesses and flattened portions, the lock hoop has a generally circular cross-section and has two hoop limbs of different lengths. The padlock may have a locking device in the lock body by means of which the lock hoop may be locked to the lock body in the closed position of said lock hoop. In this respect, the locking device may, for example, comprise two latch elements in the form of two blocking balls and may be adjusted, for example, by means of a lock cylinder between a locked position, in which the latch elements engage into respective engagement recesses in the closed position of the lock hoop, said respective engagement recesses being formed in the two hoop limbs, and an unlocked position in which the latch elements are located outside the respective engagement recess. In the open position of the lock hoop, the latch element associated with the second hoop limb may engage into a peripheral groove of the second hoop limb to secure the lock hoop to the lock body, wherein the lock hoop is, however, freely rotatable about the longitudinal axis of the longer hoop limb.

As an alternative to a purely mechanical lock cylinder, the locking device may also have, or be driven by, an electromechanical actuator (for example, an electric motor or an electromagnet).

To be able to remove the lock hoop in a conventional padlock, it may be necessary for certain lock types to first remove the lock cylinder or the electromechanical actuator and then the locking device, including its latch elements. After another lock hoop has been inserted, it is then first necessary to reinstall the locking device, including its latch elements, before the lock cylinder or the electromechanical actuator may then be inserted and the lock body of the padlock may be closed again, if necessary, by means of a base-side cover. This procedure is not only complex and/or expensive, but is relatively difficult to perform for untrained persons.

### SUMMARY OF THE INVENTION

It is therefore the underlying object of the invention to improve a padlock of the previously described kind such that the replacement of the lock hoop may be performed more easily and in particular also by untrained persons

This object is satisfied by a padlock having the features of claim 1 and in particular in that the second or the longer hoop limb has a passage that extends between the free end of the second hoop limb and the peripheral groove and that has a surface that is recessed with respect to the generally circular cross-section of the lock hoop, wherein the second hoop limb receives a blocking element between its free end and the peripheral groove, said blocking element projecting over the recessed surface of the passage in order to prevent, in the open position of the lock hoop, a passing of the latch element through the passage, starting from the peripheral groove.

Thus, if the lock hoop is in its open position, in which the latch element engages into the groove that is peripherally formed in the second hoop limb close to the free end of said second hoop limb, the hoop limb may not be unintentionally removed starting from this open position or even fall out of the lock body since the passage is blocked by the blocking element that may, for example, be a screw, in particular a screw having a defined screw head or also a grub screw, that is screwed into a bore, which may in particular be a blind bore, formed in the second hoop limb. If, on the other hand, it is desired to intentionally replace the lock hoop with another lock hoop, the blocking element may be removed from the passage for this purpose. The passage is thus no longer blocked by the blocking element so that the latch element may pass through the passage.

Since the passage extends between the free end of the second hoop limb and the peripheral groove, the free end of the second lock hoop may thus be guided past the latch element without essential components of the lock, for example the locking unit and the lock cylinder, having to removed in the previously described manner for this purpose. The replacement of the lock hoop thus proves to be very simple and may in particular also be carried out by untrained persons.

Further embodiments of the padlock in accordance with the invention will now be looked at in the following, wherein further embodiments may also result from the dependent claims, from the description of the Figures, and from the Figures themselves.

For example, in accordance with one embodiment, provision may be made that an access opening is formed in the lock body, in particular in a narrow side of the lock body, through which access opening the blocking element is accessible from outside the lock body. To obtain access to the blocking element, components or assemblies of the padlock thus likewise have to be dismantled, whereby the replacement of the lock hoop is particularly simple.

So that the padlock may not be manipulated by an unauthorized group of persons, in accordance with a further embodiment, the access opening may be formed in the lock body at a position that is located such that the blocking element is not aligned with the access opening in the closed position of the lock hoop, i.e. is not aligned with the access opening. The access opening may in particular be formed in the lock body at a position that is located such that, on a transition of the lock hoop starting from its closed position into its open position, the blocking element is aligned with the access opening before the lock hoop reaches the open position. Thus, in order to gain access to the blocking element through the access opening, the padlock has to be opened or the lock hoop has to be moved in the direction of its open position, which is only possible for authorized persons since the key of the lock cylinder is required for this purpose. Even when the lock hoop is open, the padlock and in particular the blocking element may, however, not be easily manipulated since the access opening is not aligned with the blocking element in the open position. To gain access to the blocking element through the access opening, the lock hoop rather first has to be moved starting from its open position only a short distance in the direction of its closed position so that the access opening is aligned with the blocking element. This requires precise knowledge of the operation of the padlock so that it is not easily possible to manipulate the padlock in its open position. However, in other embodiments, the access opening may be formed in the lock body at a position that is located such that the blocking element is aligned with the access opening in the open position of the lock hoop.

In accordance with a further embodiment, provision may be made that the passage is formed as a flattened portion at the lock hoop. The flattened portion in question is thus a surface of the lock hoop that is recessed with respect to the generally circular cross-section of the lock hoop and that enables a passing of the latch element starting from the peripheral groove.

Alternatively thereto, the passage may be formed as a groove, in particular a concavely arched groove, in the lock hoop that makes it possible that the latch element may exit from the peripheral groove at the second hoop limb and may move through the passage to the free end of the second lock hoop. In this respect, the design of the passage as a concave groove proves advantageous in that the lock hoop is guided through the concave shape of the groove when it is pulled out of the lock body. Thus, the lock hoop may not cant, which would otherwise make the removal of the lock hoop from the lock body more difficult.

In accordance with a further embodiment, provision may be made that the passage is formed at a flank of the second hoop limb facing away from the first hoop limb. After the removal of the blocking element through the access opening formed in the lock body has taken place, the lock hoop therefore first has to be rotated by 180° to align the passage with the latch element so that the latch element may then pass through the passage to the free end of the second hoop limb.

Since the passage is provided at the flank of the second hoop limb facing away from the first hoop limb, a defined rotational position of the lock hoop in which it may be removed is thus predefined. The corresponding rotational position of the lock hoop thus does not have to be laboriously sensed; rather, after the removal of the blocking element has taken place, it is merely necessary to rotate the lock hoop by 180° to be able to remove it from the lock body. Similarly, the manipulation security of the padlock is increased by the position of the passage at the flank of the second hoop limb facing away from the first hoop limb since it is necessary for the removal of the lock hoop to have precise knowledge of the rotational position of the lock hoop that allows a removal of said lock hoop from the lock body.

Therefore, the position of the passage at the flank of the second hoop limb facing away from the first hoop limb further proves to be advantageous since it may hereby be ensured that, once the blocking element has been removed, the lock hoop may not be easily pulled out of the lock body or even falls out of the lock body, as could be the case if the passage were provided at the flank of the second hoop limb facing the first hoop limb. In this case, in the open position of the lock hoop, the latch element could namely easily pass through the passage. To prevent this, the passage is preferably provided at the flank of the second hoop limb facing away from the first hoop limb since in this case the hoop limb first has to be rotated by 180° to be able to remove it from the lock body.

Since the dismantling of the lock hoop in the previously described manner is only possible for authorized persons, the padlock may, if necessary, be further disassembled after the dismantling of the lock hoop has taken place. Thus, the inner space of the lock body may be closed by a cover that is provided at the lower side of the lock body and that is fastened to the lock body by means of a screw that has a screw head that is located in the inner space of the lock body and that is located in axial continuation of the second hoop limb at the free end of said second hoop limb. In this respect, provision may in particular be made that the cover has, at its side facing the inner space, a receptacle into which the screw is screwed. To be able to remove the cover, the lock hoop thus first has to be removed in the previously described manner in order in this way to gain access to the screw head of the screw in question. Once the removal of the screw has taken place, the cover may thus be removed and the padlock may subsequently be further dismantled, for example, by removing the lock cylinder and the locking device.

To be able to secure the cover particularly reliably to the lock body, the latter may, in accordance with a further embodiment, have a recess in its inner space in axial continuation of the first hoop limb, said recess receiving a section of the cover, such as a nose projecting from the cover, in a form-fitting manner. An undercut is thus formed that prevents the cover from accidentally loosening and falling down after the screw securing the cover to the lock body has been released.

To make the best possible use of the installation space available within the lock body, a lock cylinder provided for actuating the locking device may be arranged off-center and obliquely within the lock body. Provision may in particular be made in this respect that the lock cylinder has a main plane of extent, which is tilted with respect to a plane defined by the two hoop limbs, wherein the lock cylinder is arranged off-center with respect to an axis defined centrally between the two lock hoops.

### DRAWINGS

The invention will now be explained in the following in a purely exemplary manner with reference to the drawings in which:

FIG. 1 shows a perspective representation of a padlock in accordance with the invention; and

FIG. 2 shows a partly resolved perspective representation of the padlock of FIG. 1 with a removed lock body.

### DESCRIPTION OF THE INVENTION

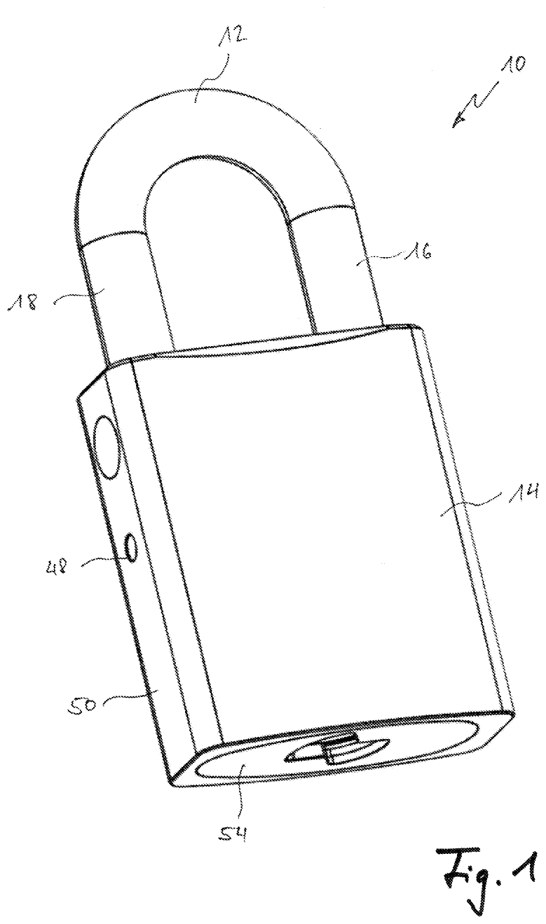

As can be seen from FIG. 1, a padlock 10 in accordance with the invention has a lock body 14 and a U-shaped lock hoop 12 that has a generally circular cross-section and that may be displaced in a manner conventional per se at the lock body 14 between a closed position and an open position, wherein it may be rotated with respect to the padlock 10 in the open position. The lock body 14 and the lock hoop 12 may be produced from a metallic material; alternatively thereto, provision may, however, likewise be made that the lock hoop 12 and/or the lock body 14 is/are produced from a plastic material.

The lock hoop 12 has a first hoop limb 16 and a second hoop limb 18 that is longer than the first hoop limb 16. In the closed position of the lock hoop 12 shown in FIG. 1, the first hoop limb 16 is received by a first receiving passage (not shown) formed in the lock body 14 and, in a corresponding manner, the second hoop limb 18 is also received by a second receiving passage formed in the lock body 14.

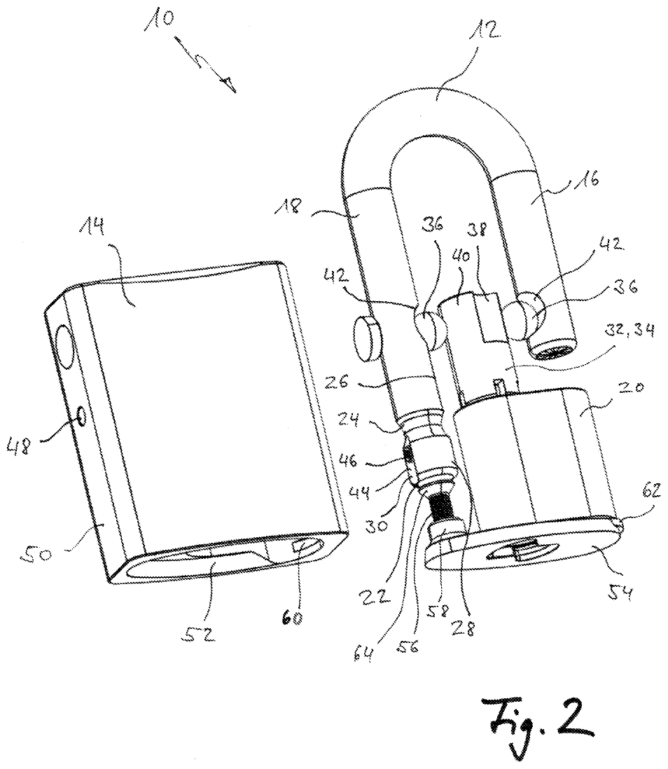

To be able to secure the lock hoop 12 to the lock body 14 in the closed position shown in FIG. 2, a locking device 32 is provided in the inner space of the lock body 14 and comprises a rotating latch 34 and two latch elements in the form of two blocking balls 36. The rotating latch 34 is in this respect rotatably supported in the lock body 14 between the two receiving passages, and indeed about an axis of rotation that is aligned in parallel with the longitudinal extent of the two receiving passages.

The rotating latch 34 is a substantially cylindrical body, but two mutually diametrically oppositely disposed release sections 38 are formed in its peripheral surface in the form of two concave recesses, of which only one can be recognized in FIG. 2 based on the currently depicted rotational position of the rotating latch 34. On the other hand, the recess-free peripheral sections of the rotating latch 34, which are formed between the two release sections 38, form locking sections 40 of the rotating latch 34 whose function will be looked at in more detail below.

The release sections 38 radially recessed with respect to the locking sections 40 serve to receive the two blocking balls 36 in the release position of the rotating latch 34 (not shown) in which the lock hoop 12 may be freely displaced to and fro between its closed position and its open position. If the rotating latch 34 is, on the other hand, rotated about its axis of rotation, the blocking balls 36 are urged radially outwardly along the concave surfaces of the release sections 38 until they are radially aligned with the locking sections 40, as is shown in FIG. 2. In this locked position of the rotating latch 34, the two blocking balls 36 engage into respective engagement recesses 42 that are formed at the inner side of the first and second hoop limbs 16, 18, whereby the lock hoop 12 is fixedly locked to the lock body 14, see FIG. 2 in this respect.

Thus, depending on the rotational position of the rotating latch 34, the two blocking balls 36 are therefore urged radially outwardly into the engagement recesses 42 of the two hoop limbs 16, 18 or released so that they may move radially inwardly to release the lock hoop 12. In some embodiments, the rotating latch 34 may indeed be preloaded in the direction of its locked position by means of a torsion spring so that it automatically returns to its locked position, starting from its release position. In the embodiment shown, such a torsion spring is, however, not provided since it should only be possible to remove the key of the lock cylinder 20 in the locked position of the rotating latch 34.

In the embodiment shown here, the rotating latch 34 is actuated via a lock cylinder 20 by means of an associated key, for which purpose the cylinder core of the lock cylinder 20 is connected in a form-fitting manner to the rotating latch 34.

Alternatively thereto, the rotating latch 34 may, however, also be driven by means of an electromechanical actuator, for example an electric motor, for which purpose the drive shaft of the electric motor may be coupled to the rotating latch 34 in a drive-effective manner (for example directly or via a gear). In contrast to the purely mechanical design of the padlock shown here, the padlock may thus also have an electromechanical locking mechanism.

As can further be seen from the representation of FIG. 2, a peripheral groove 24, which may also be referred to as an annular groove, is formed in the vicinity of the free end 22 of the second hoop limb 18. The peripheral groove 24 is located closer to the free end 22 of the second hoop limb 18 than the engagement recess 42 which is formed at the second hoop limb 18 and into which the blocking ball 36 associated with the second hoop limb 18 engages in the closed position of the lock hoop 12 shown in FIG. 2.

Even if this cannot be seen from the representation of FIG. 2, the engagement recess 42 at the flank of the second hoop limb 18 facing the first hoop limb transitions in a manner known per se to an axially extending flattened portion 26 that is recessed with respect to the circular cross-section of the lock hoop by a dimension that is less than the depth of the engagement recess 42. At the end disposed opposite the engagement recess 42 in the axial direction, the flattened portion 26 merges into the peripheral groove 24 whose depth corresponds substantially to the amount by which the flattened portion 26 is recessed with respect to the circular cross-section of the lock hoop 12.

This peripheral groove 24 is adjoined in the axial direction by a substantially cylindrical end section 28 of the second hoop limb 18 by which it is prevented that the lock hoop 12 may be unintentionally removed from the lock body 14. If the lock hoop 12 is namely transferred starting from the closed position shown in FIG. 2 into its open position, for which purpose the rotating latch 34 first has to be rotated so that the blocking balls 36 may enter into its release sections 38, the blocking ball 36 associated with the second hoop limb 18 may pass through the flattened portion 26 and may enter up to and into the peripheral groove 24 in which it is captured by the end section 28.

To be able to remove the lock hoop 12 from the lock body 14 if required, a passage 30, which has a surface 44 that is recessed with respect to the circular cross-section of the lock hoop 12, is formed in the substantially cylindrical end section 28 of the second hoop limb 18 between the free end 22 of the second hoop limb 18 and the peripheral groove 24 at or in the flank of the second hoop limb 18 facing away from the first hoop limb 16. In the embodiment shown here, the passage 30 is formed as a concave groove. Alternatively thereto, the passage 30 may, however, also be a simple flattened portion of the lock hoop 12 that defines a substantially planar surface that is recessed with respect to the circular cross-section of the lock hoop 12. The passage 30 extends in the axial direction, i.e. along the longitudinal axis of the second hoop limb 18.

As can furthermore be seen from FIG. 2, a selectively releasable blocking element 46 in the form of a screw, which may, for example, be a screw having a defined screw head or also a grub screw, is located in the passage 30, said screw being screwed into a blind bore formed in the second hoop limb 18 and projecting with its screw head over the recessed surface of the passage 30. In other words, in the embodiment shown here, the screw head is located in the passage 30 formed as a concave groove. The passage 30 is thus blocked by the blocking element 46 in the form of the screw in question so that the blocking ball 36 associated with the second hoop limb 18 may not pass through the passage 30 starting from the peripheral groove 24 after the lock hoop 12 has been rotated by 180° starting from the rotational position shown in FIG. 2. The blocking element 46 may in particular be oriented radially with respect to the longitudinal axis of the second hoop limb 18.

If, on the other hand, it is desired to remove the lock hoop 12 in order to replace it with another lock hoop, for example, the blocking element 46 may be removed for this purpose through an access opening 48 formed in the narrow side 50 of the lock body 12, for example with the aid of a screwdriver or a hexagon socket wrench that may be brought into engagement with the screw head of the blocking element 46 configured as a grub screw. If the blocking element 46 is released in this manner and removed through the access opening 48 of the lock body 14, the blocking ball 36 associated with the second hoop limb 18 may pass through the passage 30, for which purpose the lock hoop 12 has to be rotated by 180° with respect to the rotational position shown in FIG. 2 since the passage 30 is located at the flank of the second hoop limb 18 facing away from the first hoop limb 16. Since the blocking ball 36 associated with the second hoop limb 18 may thus pass through the passage 30 after the lock hoop 12 has been rotated by 180°, the lock hoop 12 may thus be removed from the lock body 14 in the desired manner if required.

In this respect, the access opening 48 is formed in the lock body 14 at a position that is located such that, on a transition of the lock hoop 12 starting from its closed position shown in FIG. 2 into its open position, in which the blocking ball 36 associated with the second hoop limb 18 is located in the peripheral groove 24, the blocking element 46 is aligned with the access opening 48 before the lock hoop 12 reaches the open position. If the lock hoop 12 is therefore transferred starting from the closed position shown in FIG. 2 in the direction of its open position, the blocking element 46 first passes through the access opening 48 before the blocking ball 36 associated with the second hoop limb 18 reaches the peripheral groove 24 in the open position of the lock hoop 12.

As can furthermore be seen from FIG. 2, the lock body 14 has an opening 52 at its lower side, through which opening 52 the inner space of the lock body 14 is accessible. This opening 52 is closed by a cover 54 that is fastened to the lock body 14 by means of a screw 56 whose screw head 64 is located in the inner space of the lock body 14. More precisely, the screw head 64 of the screw 56 is located in axial continuation of the second hoop limb 18 at the free end of said second hoop limb 18, wherein the shaft of the screw 56 is screwed into a receptacle 58 that is formed at the side of the cover 54 facing the inner space of the lock body 14.

In some embodiments, an ejection spring by which the lock hoop 12 is preloaded into its open position may indeed be provided between the free end 22 of the second hoop limb 18 and the screw head 64 of the screw 56. In the embodiment of the padlock 10 described here, the lock hoop 12 was, however, not preloaded in the direction of its open position by means of a corresponding ejection spring.

Since the screw head of the screw 56 is accessible only after the lock hoop 12 has been dismantled, the cover 54 may only be removed from the lock body 14 by authorized persons. To be able to secure the cover 54 particularly reliably to the lock body 14, a slot-shaped recess 60 is provided in the inner space of the lock body 14 in axial continuation of the first hoop limb 16, said slot-shaped recess 60 receiving a nose 62 projecting from the cover 54 in a form-fitting manner. The nose 62 thus engages behind the lower end of the lock body 14 so that the latter is particularly reliably secured to the lock body 14 after a screwing by means of the screw 56 has taken place.

What is claimed is:

1. A padlock comprising:
a lock body;
a U-shaped lock hoop that has a generally circular cross-section, that is displaceably held at the lock body between a closed position and an open position, and that has a first hoop limb and a second hoop limb that is longer than the first hoop limb; and
a locking device in the lock body for locking the lock hoop to the lock body in the closed position of the lock hoop,
wherein the locking device comprises at least one latch element and can be adjusted between a locked position, in which the latch element engages into an engagement recess in the closed position of the lock hoop, the engagement recess being formed in a flank of the second hoop limb facing the first hoop limb, and an unlocked position in which the latch element is located outside the engagement recess,
wherein, in the second hoop limb, a peripheral groove is formed which is located closer to a free end of the second hoop limb than the engagement recess and into which the latch element engages in the open position of the lock hoop,
wherein the second hoop limb has a passage that extends between the free end of the second hoop limb and the peripheral groove and that has a surface that is recessed with respect to the generally circular cross-section of the lock hoop, and
wherein the second hoop limb receives a blocking element between its free end and the peripheral groove, the blocking element projecting over the recessed surface of the passage in order to prevent, in the open position of the lock hoop, a passing of the latch element through the passage, starting from the peripheral groove.

2. The padlock in accordance with claim 1, wherein the passage is formed as a flattened portion at the lock hoop or as a concave groove in the lock hoop.

3. The padlock in accordance with claim 1, wherein the passage is formed at a flank of the second hoop limb facing away from the first hoop limb.

4. The padlock in accordance with claim 1, wherein the blocking element is a screw that is screwed into a bore formed in the second hoop limb.

5. The padlock in accordance with claim 4, wherein the bore is a blind bore.

6. The padlock in accordance with claim 1, wherein an access opening is formed in the lock body, through which access opening the blocking element is accessible from outside the lock body.

7. The padlock in accordance with claim 6, wherein the access opening is formed in a narrow side of the lock body.

8. The padlock in accordance with claim 6, wherein the access opening is formed in the lock body at a position that is located such that, on a transition of the lock hoop starting from its closed position into its open position, the blocking element is aligned with the access opening before the lock hoop reaches the open position.

9. The padlock in accordance with claim 1, wherein the lock body forms an inner space that is closed at the lower side of the lock body by a cover, wherein the cover is fastened to the lock body by means of a fastening screw, and wherein the fastening screw has a screw head that is located in the inner space of the lock body and that is located in axial continuation of the second hoop limb adjacent to the free end of said second hoop limb.

10. The padlock in accordance with claim 9, wherein the cover has, at a side facing the inner space of the lock body, a receptacle into which the fastening screw is screwed.

11. The padlock in accordance with claim 9, wherein the lock body has a recess in its inner space in axial continuation of the first hoop limb, said recess receiving a section of the cover in a form-fitting manner.

12. The padlock in accordance with claim 1, wherein a lock cylinder is provided in the lock body for actuating the locking device, said lock cylinder having a main plane of extent, which is tilted with respect to a plane defined by the two hoop limbs, and being arranged off-center with respect to an axis defined centrally between the two lock hoops.

13. A padlock comprising:
a lock body comprising two broad sides and two narrow sides;
a U-shaped lock hoop that is displaceably held at the lock body between a closed position and an open position, wherein the lock hoop has a first hoop limb and a second hoop limb having a generally circular cross-section; and
a latch element in the lock body for locking the lock hoop to the lock body in the closed position of the lock hoop;
wherein the second hoop limb is longer than the first hoop limb, the second hoop limb having a free end, an engagement recess, a peripheral groove that is located between the free end and the engagement recess, and a passage that extends between the free end and the peripheral groove, wherein the engagement recess of the second hoop limb is formed in a peripheral region of the second hoop limb that faces the first hoop limb, and wherein the passage of the second hoop limb is recessed with respect to the generally circular cross-section of the second hoop limb;
wherein the latch element can be moved between a locked position and an unlocked position, wherein in the locked position the latch element engages into the engagement recess of the second hoop limb in the closed position of the lock hoop, and wherein in the unlocked position the latch element is located outside the engagement recess of the second hoop limb;
wherein in the open position of the lock hoop the latch element engages into the peripheral groove of the second hoop limb;
wherein the second hoop limb comprises a removable blocking element that is located between the free end and the peripheral groove of the second hoop limb, wherein the blocking element projects from the passage such that the blocking element, in the open position of the lock hoop, blocks the latch element from passing from the peripheral groove along the passage to the free end of the second hoop limb; and
wherein an access opening is formed in the lock body through which the blocking element is accessible for removing the blocking element from the second hoop limb, wherein the access opening is formed in one of the narrow sides of the lock body.

14. The padlock in accordance with claim 13, wherein the passage of the second hoop limb is formed in a peripheral region of the second hoop limb facing away from the first hoop limb.

15. The padlock in accordance with claim 13, wherein the access opening is located at the lock body such that the access opening is aligned with the blocking element when the lock hoop is in an intermediate position between the closed position and the open position.

16. A padlock comprising:
a lock body;
a U-shaped lock hoop that is displaceably held at the lock body between a closed position and an open position, wherein the lock hoop has a first hoop limb and a second hoop limb having a generally circular cross-section; and
a latch element in the lock body for locking the lock hoop to the lock body in the closed position of the lock hoop;
wherein the second hoop limb is longer than the first hoop limb, the second hoop limb having a free end, an engagement recess, a peripheral groove that is located between the free end and the engagement recess, and a passage that extends between the free end and the peripheral groove, wherein the engagement recess of the second hoop limb is formed in a peripheral region of the second hoop limb that faces the first hoop limb, and wherein the passage of the second hoop limb is recessed with respect to the generally circular cross-section of the second hoop limb;
wherein the latch element can be moved between a locked position and an unlocked position, wherein in the locked position the latch element engages into the engagement recess of the second hoop limb in the closed position of the lock hoop, and wherein in the unlocked position the latch element is located outside the engagement recess of the second hoop limb;
wherein in the open position of the lock hoop the latch element engages into the peripheral groove of the second hoop limb;
wherein the second hoop limb comprises a removable blocking element that is located between the free end and the peripheral groove of the second hoop limb, wherein the blocking element projects from the passage such that the blocking element, in the open position of the lock hoop, blocks the latch element from passing from the peripheral groove along the passage to the free end of the second hoop limb; and
wherein an access opening is formed in the lock body through which the blocking element is accessible for removing the blocking element from the second hoop limb, wherein the access opening is located at the lock body such that the access opening is aligned with the blocking element when the lock hoop is in an intermediate position between the closed position and the open position.

17. The padlock in accordance with claim 16, wherein the passage of the second hoop limb is formed in a peripheral region of the second hoop limb facing away from the first hoop limb.
